(19) United States
(12) Patent Application Publication
(10) Pub. No.: US 2025/0373041 A1
(43) Pub. Date: Dec. 4, 2025

(54) SOLAR-BASED MULTIPURPOSE UTILITY SYSTEM

(71) Applicant: Council of Scientific and Industrial Research and Indian Registered Body Incorporated Under The Regn, New Delhi (IN)

(72) Inventors: Swades Kumar CHAULYA, Dhanbad (IN); Girendra Mohan PRASAD, Dhanbad (IN); Sujit Kumar MANDAL, Dhanbad (IN); Gautam BANERJEE, Dhanbad (IN); Surajit DEY, Dhanbad (IN); Virendra KUMAR, Dhanbad (IN); Naresh KUMAR, Dhanbad (IN); Preity -, Dhanbad (IN); Vijay Kumar RAWANI, Dhanbad (IN); Gopaljee SAW, Dhanbad (IN)

(21) Appl. No.: 18/869,672

(22) PCT Filed: May 16, 2023
(86) PCT No.: PCT/IN2023/050460

§ 371 Date: Nov. 26, 2024

(30) Foreign Application Priority Data
May 27, 2022 (IN) 202211030751

(51) Int. Cl. H02J 7/00; H02J 7/35; H02S 40/22; H02S 40/44

(52) U.S. Cl. CPC H02J 7/0068; H02J 7/35; H02S 40/22; H02S 40/44

(57) ABSTRACT

The present invention provides a solar-based multipurpose utility system which is an integrated appliance that uses solar energy to perform various utility functions such as cooking, ice melting, water heating, room heating, and food drying. The phase change material has been used in the system for enhancing the thermal storage capacity of the system. The invention supports the idea of providing wireless remote control for the overall system to the end-user using IoT-based sensors and devices. The system comprises Fresnel lens with cover (21), Fresnel lens (22), ice pot (23), water pipe (24), reflector (25), water storage tank (26), blower (13), phase change material (PCM) filled in evacuated tube arrangement (27), hot air sprayer (28), water filter (15), battery with electronic components (3), water tap (29), temperature and humidity sensor (16), exhaust fan (12), and solar panel (1).

### FIELD OF THE INVENTION

The present invention relates to a solar-based multipurpose utility system. The present invention particularly relates to a multiuse system for performing cooking and ice melting using solar energy as well as room heating, water heating and food drying using phase change material. The present invention more particularly relates to a system for operating during day and night using solar energy, phase change material (PCM) and energy storage arrangement as well as remote monitoring and controlling of the system parameters using Internet of Things (IoT)-enabled devices. The solar-based multipurpose utility system of the instant invention has been designed and fabricated using affordable and clean energy, especially for domestic use or for remote areas. The invention shall help attain the 6^{th} sustainable development goal of Energy (conventional and non-conventional) and Energy devices.

### BACKGROUND

Currently, energy consumption for cooking, ice melting, room heating, water heating, food drying, water distillation is considered to be major component of total energy consumption in various households and commercial sectors. Demands and prices of fuels are increasing day by day. Thus, as an alternative fuel, solar energy is a good option to be utilized for various heating and cooling applications.

Reference may be made to U.S. Pat. No. 4,606,402A, wherein an apparatus has been described and claimed for melting ice at low temperatures on building roof eaves by using solar energy. The system consists of a solar collector and an arrangement of insulated tubes which also provides the function of water run-off for the melting ice. However, the drawbacks thereof are that the system does not have any facility for solar-based room heating. The system only defines the use of solar energy to melt ice into water. The system does not facilitate the use of solar energy for conventional energy-based applications like cooking and food drying. The system also has no provision for automatic temperature controlling for solar ice to water melting application.

Reference may be made to EP3306223A1, wherein an apparatus has been described and claimed as a multifunctional solar energy system for providing a converging system and two solar energy utilization devices, wherein the converging system includes at least one light-focusing refractive surface and one reflective surface, which is arranged below the light-focusing refractive surface along a solar incident direction. However, the drawbacks of the said patent are that the system does not provide any facility or mechanism for ice to water conversion. Also, the system does not have any facility for solar-based room heating. The system is also not capable of providing a facility for food drying which will allow farmers to preserve their harvest for a longer time.

Reference may be made to CN101832652B, wherein a system has been described and claimed for the invention relates to a combined system for providing an automatic tracking solar cooker, a solar water heater, and a solar photovoltaic generating system. The system comprises a solar tracking arrangement, paraboloids for light collecting and reflecting. However, the drawbacks thereof are that the system does not have any facility for solar-based food drying and ice melting. The system also doesn't contain any kind of system parameter control features which is very much required for cooking.

Reference may be made to CN201897325U, wherein a system has been described for a portable flat solar cooker, which comprises a Fresnel lens, wherein the polished side of the Fresnel lens is connected with supporting legs, a space surrounded by the supporting legs can accommodate a cooking utensil, and the focus of the Fresnel lens is in the space surrounded by the supporting legs. The portable flat solar cooker disclosed by the utility model has a small volume, a lightweight, convenience in carrying, high condensation efficiency and rapid temperature rise; and also, the supporting legs are detachably connected with the Fresnel lens, the Fresnel lens is formed by assembling four lenses, so the portability is further improved, and the portable flat solar cooker disclosed by utility model is particularly suitable to be used in outdoor temporary construction. However, the drawbacks of the said patent are that the system does not have any facility for the utilization of solar energy for food drying, room heating, and ice melting. Also, the system has no mechanism for automatic control of temperature for cooking and heating.

Reference may be made to CA2457119A1, wherein a system has been described and claimed for a solar cooker of the concentrating type, using compound parabolic concentrator type optics comprising box, inside which all its accessories and cooking utensils can be carried; the box is essentially made of plastic compatible with the production of complicated curves characteristic of the referred optics. It includes a feature in which electrical energy is used as a backup for days without sunlight. It can be used in different applications like pasteurization of water, milk and other products and can be used as a drying system. However, the drawbacks of the said patent are that the system is a little complex as it requires frequency adjustment of the cooker due to high temperature. The system also has no facility for control of temperature for the cooking and drying process.

Reference may be made to CN1884938A, wherein a system has been described for a sealed high-efficiency solar furnace, formed by focusing system and furnace, wherein the furnace is one sealed chamber packed with thermal-insulated material. The system also consists of a reflective lens and focus lens which provides the focused solar light to the cooking chamber. However, the drawbacks thereof are that the system does not have any facility for the utilization of solar energy for food drying, ice melting, and room heating. This invention also does not have a feature of temperature control for cooking.

Reference may be made to U.S. Pat. No. 9,655,469B2, wherein a portable solar-based cooker has been described. The portable solar cooker not only has functions of boiling water and cooking foods, but also has the advantages of facilitating carrying and tracking the sun and can achieve full utilization of solar energy anytime and anywhere. However, the drawbacks of the said patent are that the system has the facility only for solar cooking and tracking and doesn't provide any facility for solar-based food drying, ice melting and room heating. The system also has no provision to control temperature for cooking.

Reference may be made to U.S. Pat. No. 4,083,357A, wherein a solar heating system has been recited for the cooking of food which consists of a parabolic trough reflector and oven assembly. The reflector assembly also has an aiming device mounted on its perpendicular support to assure reflector focus through shadows. However, the drawbacks thereof are that the system can only be used for cooking. The system has no provision for solar-based drying, ice melting, and room heating. The system also doesn't have any facility to control temperature for cooking purposes.

Reference may be made to CN103307766A, wherein a system has been described and claimed for solar energy utilization system, which utilizes solar energy for cooking. The system is based on the principle of using a point focusing solar mirror and application of the point focusing solar mirror to a moving point array solar cooker. The system also has the functionality of the tracking control which controls the solar mirrors to focus sunlight to at least one solar cooker when the sunlight changes. However, the drawbacks are that the system only defines the solar energy utilization system for cooking. The system doesn't provide any facility for solar-based drying, room heating and ice melting.

Reference may be made to JP2010266138A, wherein a solar-based cooker cum water heater system has been described, in particular to a system that utilizes solar energy for cooking and water heating applications. The invention consists of a multi-layer heat-insulating window and sealed by a highly heat-insulating container, and the inner surface of the container is used as a solar heat absorber. However, the drawbacks of the said patent are that the system does not have any facility for utilization of solar energy for food drying and ice melting applications. The system does not have the technology for control of temperature for the food cooking process.

Reference may be made to CN101008503A, wherein a high-effect multifunctional solar water heater device has been described. The invention comprises a separated vacuum tube heat collector, a tube heat exchanger, a ground heat exchanger, a heat collecting water box, an electric water heater, and a ground heat module. However, the drawbacks thereof are that the system only defines the water heating system. The system doesn't provide any facility for solar-based cooking, food drying, and ice melting. The system also has no provision for temperature control which is used to the control temperature for cooking, drying, and heating applications.

Reference may be made to CN200996675Y, wherein an all-purpose solar energy water heater system has been described. The device comprises a separable evacuated tubular solar air heater, a heat-pipe exchanger, a terrestrial heat exchanger, a heat collection water tank, an electric water heater, and a terrestrial heat module. The invention also has a water mixing valve along with a cold-water inlet for bathing. However, the drawbacks of the said patent are that the system only defines the water heating system. The system doesn't provide any facility for solar-based cooking, food drying, and ice melting. The system also has no provision for temperature control which is used to control the temperature for cooking, drying, and heating applications.

Reference may be made to FR2966566A1, wherein a food drying system which uses solar energy for drying and dehydrating food materials has been described. The system contains sensors and is portable. However, the drawbacks thereof are that the system is designed only for food drying in the presence of sunlight. The system has no feature for utilizing solar energy for other functions like room heating, ice melting, cooking, and water heating. The system does not have a facility for power backup for facilitating it in the absence of sunlight.

Reference may be made to U.S. Pat. No. 4,213,448A, wherein a fluid thermosiphon system that provides solar-based space heating function system has been described. The system contains phase change materials along with a fluid thermosiphon system latched up with valves. However, the drawbacks of the said patent are that the system is designed only for space heating. The system has no feature for the utilization of solar energy for water heating, food drying, cooking and ice melting.

Reference may be made to CN100334179C, wherein a water heating system that utilizes solar energy and a phase change heat storage material has been described. The phase change material used for heat storage has a very high phase change potential heat and guarantees no toxicity, no corrosion and stable performance. However, the drawbacks thereof are that the system only defines the solar water heating system using phase change materials. The system doesn't provide any facility for utilizing solar energy for cooking, ice melting, food drying, and room heating. The system also has no provision for providing power backup to the system in the absence of sunlight.

Reference may be made to US20150040888A1, wherein an effective method to collect and store heat in a solar collector for delayed-release system has been described. The system contains an evacuated tube collector, where phase change material is placed directly inside the void space of the collector tube. However, the drawbacks thereof are that the system does not have any facility for providing power backup to the system. The system is also not capable of providing remote control of the system to the end-user.

Reference may be made to the publication by Saxena, A. and Srivastava, G. 2013. Int J Mechanical Engineering. Vol. 3 (1): 21 to 33 pages, wherein a multipurpose solar energy system has been designed and fabricated especially for domestic use or remote areas. The developed system consists of a solar-based cooker, water heater, and dryer. The system also consists of photovoltaic solar cells that allow the system to function even in the absence of sunlight or in rainy weather. However, the drawbacks of the cited system are that it does not have any facility for solar based ice melting or for room heating using solar energy. The system also has a slow drying rate as it is based on natural convection mode of heat transfer.

Reference may be made to the publication by Zhao, Y. et al. 2018. Solar Energy. Vol. 174:236 to 272 pages, wherein a novel portable solar cooker is designed using a curved Fresnel lens as the concentrator. The developed system consists of a Fresnel lens concentrator and an evacuated tube assembly. It also provides a high concentration ratio and allows tracking the sun in both zenith and azimuth angles manually. However, the drawbacks of the cited art are that the system does not have any facility for the utilization of solar energy for food drying, ice melting, water heating and room heating. The system is not capable of providing power backup for the working of the system in the absence of sunlight and doesn't have a facility for temperature control.

Reference may be made to the publication by Sayyad, F. G. et al. 2015. Current World Environment. Vol. 10 (3): 985 to 993 pages, wherein a solar cooker cum dryer has been designed, developed and fabricated. The developed system contains PVC pipes, valves, a cooking chamber that converts into a solar collector in drying mode of operation. However, the drawbacks of the said article are that the system can't be used in the absence of sunlight. The system is not capable of utilising solar energy for ice melting, room heating and water heating and does not have an automatic temperature control mechanism for food drying purposes.

Thus, keeping in view the drawbacks of the hitherto reported prior art, the inventors of the present invention realized that there exists a dire need to provide a multipurpose solar utility system comprising a Fresnel lens and reflector arrangement, phase change material filled in the evacuated tubes, blower, solar panel, IoT-enabled sensors and devices which can perform cooking and ice melting using solar energy as well as room heating, water heating and food drying using phase change material, which is operable day and night using solar energy because of energy storage arrangement as well as capable of remote monitoring and controlling using Internet of Things (IoT)-enabled devices.

### OBJECTIVES OF THE INVENTION

The main objective of the present invention is therefore to provide a multipurpose solar utility system for performing various tasks covering cooking, ice melting, room heating, food drying, and water heating, which obviates the drawbacks of the hitherto known prior art.

Another objective of the present invention is to provide a solar-based cooking and ice melting unit using a combination of Fresnel lens for converging and concentrating sun's rays from the top and front portion of the system which allows ice storage unit and cooking pot to be heated efficiently.

Still another objective of the present invention is to provide rotating screw jack and hinge-based mechanism for variation of temperature by adjusting inclination or height of lens and reflector arrangement to fulfil the requirement of variable heat intensity for cooking and ice melting purpose.

Yet another objective of the present invention is to provide a wireless control to the system through IoT-based sensors and devices powered by solar panel which allows the end-user to turn on/off the system for controlling drying rate by varying rate of moisture, hot air flow rate and temperature.

Still yet another objective of the present invention is to provide a system incorporated with solar-based water heating, food drying, and room heating facilities using the phase change materials for solar thermal storage along with the positive temperature coefficient (PTC) air heater with forced convection to continue drying application in case of cloudy/foggy weather.

A further objective of the present invention is to develop a system using solar energy as the main source of power supply in energy deficit areas as well as AC mains supply as an auxiliary source for continuous operation of the system even in the absence of sunlight.

### SUMMARY OF THE INVENTION

The present invention relates to the development of a multifunctional solar-based utility system. The present invention provides a system for performing multiple utility tasks, like cooking, room heating, food drying, ice melting, and water heating. The device developed in the present invention consists of different sub-units, including a cooking and an ice melting unit which uses a combination of Fresnel lens for converging and concentrating sun's rays from the top and front portion of the system; a room heating, water heating, and food drying units based on phase change material thermal storage technique and evacuated tubes; a wireless remote control unit and multiple set of sensors for temperature monitoring and controlling. For both ice melting and cooking, direct sunlight from top Fresnel lens and reflected sunlight for lens-reflector arrangement is utilized for melting the ice kept in an ice-storage unit. The water obtained by the ice melting unit is transported through a water pipe. The Fresnel lens and a reflector is arranged in such a way that it can handle the varying heat energy requirements for cooking and ice melting by tilting the lens to align it with sun as per the need. Water obtained from the ice melting unit gets collected into a water storage tank. Power supply from solar panel is provided to the microcontroller, wireless module and other sensors and devices. Microcontroller is used for reading the sensor values and the monitoring data which is uploaded to the cloud through NodeMcu (ESP8266), a Wi-Fi-enabled low-cost module. This IoT-based system can be accessed and remotely controlled from anywhere using the Internet. The food dryer uses a blower for pumping the air suction from the environment into the evacuated tube arrangement for the purpose of food drying as well as room heating. For food drying, room heating and water heating, an evacuated tube-based heating arrangement is used. The blower also draws air through the air heater as well as the tubes embedded in the PCM of the energy storage in case of power cut. The hot air sprayer utilizes heat obtained from evacuated tube collector. The water obtained by the ice melting is transported through a water pipe to a water storage tank where it is passed either through a set of evacuated tube heating arrangement for water heating purposes or a water filter for direct use for drinking and cooking purposes as per the user requirement. A box contains required battery and electronic components needed for operating and sensing the system parameters. The drinkable water is obtained through tap connected to the storage tank. All the three sensors, namely airflow, temperature and humidity sensors are used for accurate and continuous sensing of heating and drying rate parameters. One more sensor, pyranometer is provided for measuring the solar irradiance on the planar surface of the system. The values obtained from these sensors are processed by the micro-controller. One exhaust fan is connected to remove the moisture out of the cooking and ice melting units. The real-time readings can also be displayed on an OLED display connected to the apparatus. The heating arrangement consists of a series of evacuated tubes, made up of borosilicate glass, under which an aluminum pipe is inserted and phase change material is sandwiched between the two aluminum pipes and. U-shaped copper tube is placed into the aluminum layered tube for the heating purposes by utilizing paraffin wax and stearic acid as PCM material.

In an aspect, the present invention provides a solar-based multipurpose utility system as claimed in claim 1, wherein it comprises:
(a) a cooking and ice melting unit based on a lens-reflector arrangement consisting of Fresnel lens and mirror reflector;
(b) a room heating, water heating, and food drying units using a thermal storage unit based on phase change material and evacuated tubes;
(c) a wireless remote-control unit based on IoT-enabled devices;
(d) multiple set of sensors for temperature monitoring and controlling; and
(e) a display unit to view the readings of different system parameters, like temperature, humidity, rate of hot air flow for solar drying application.

### BRIEF DESCRIPTION OF THE DRAWINGS

The present invention is illustrated in FIGS. 1 to 3 of the drawings accompanying this specification. In the drawings, like reference numbers indicate corresponding parts in the various figures.

FIG. 1 shows the block diagram of solar-based multipurpose utility system consisting of different sub-units (1) to (20) of the whole system.

FIG. 2 illustrates the system diagram of solar-based multipurpose utility system which is enabled with lens-reflector arrangement, thermal energy storage. The system diagram consists of different sub-units (21) to (29) including (1), (3), (12), (13), (15), and (16).

FIG. 3 represents the structural design of the evacuated tube heating arrangement which is a major part of solar-based multipurpose utility system, which consists of different sub-units (30) to (33).

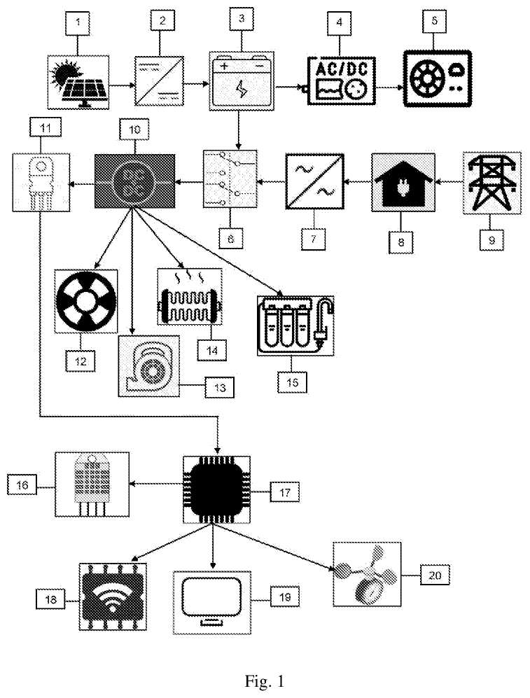

The details of the FIGS. 1 to 3 are given below:

FIG. 1 represents the block diagram of the solar-based multipurpose utility system wherein the system consists of different parts, like solar panel (1), charge controller (2), battery (3), inverter (4), supply for external sources (5), change-over circuit (6), AC-DC converter (7), mains AC supply (8), external AC supply source (9), DC-DC converter (10), voltage regulator (11), exhaust fan (12), blower (13), positive temperature coefficient (PTC) air heater (14), water filter (15), temperature and humidity sensor (16), microcontroller (17), wireless module NodeMcu (18), OLED display (19), and air flow meter (20). Solar panel (1) absorbs rays of sunlight and converts it into electricity. A charge controller (2) is connected to the solar panel to protect the battery from overcharging by regulating the voltage and current coming from the solar panel (1) to the battery (3). Inverter (4) mainly converts DC current to AC current and gives indication of low battery, main charging, solar charging, eco mode etc. Battery (3) stores DC power backup and it is mainly used in case of lack of electricity. Charge controller (2) has six terminals in which two terminals are for the solar panel, two terminals for the battery (3) and the other two terminals are for the DC output. In the block diagram at first, a 24 V solar panel (1) is connected to the solar charge controller (2) and then a 24 V battery (3) is connected to the charge controller (2). An inverter (4) is connected to the battery (3). The output of the inverter (4) is then connected to the supply for external sources (5). External AC supply (9) is connected to AC mains supply (8) which provides input to the rectifier circuit (7). The changeover circuit (6) takes input from both battery (3) and rectifier (7). Buck boost DC-DC converter (10) provides 12 V DC supply to blower (13), PTC air heater (14), water filter (15) and exhaust fan (12). A 5 V regulated output is provided to the microcontroller (17) from a voltage regulator (11) connected to buck boost DC-DC converter (10) which processes the values obtained from different sensors namely temperature, humidity (16) and air flow sensors (20). The said microcontroller (17) output is also connected to Wi-Fi module (18) and OLED display (19). The final readings are displayed on an OLED display (19). The microcontroller (17) communicates with a wireless module (18) to initiate and transmit data to the cloud server. An Arduino microcontroller (17) is used for reading the sensor values and the monitoring data which is uploaded to the cloud through NodeMcu (18), a Wi-Fi-enabled low-cost module. The system consists of multiple IoT-based sensors that collects various data continuously and transmits to the web server through wireless modules (18). Power supply from solar panel (1) is provided to the microcontroller (17), wireless module (18) and other sensors (16 and 20). This IoT based system can be accessed and remotely controlled from anywhere using the Internet. The end-user can change/control drying rate, temperature and humidity level in the dryer chamber by varying the hot air flow rate into it. These data are received by a significantly designed application interface running on a mobile or personal computer which is connected through a Wi-Fi module (18). All the three sensors, namely temperature (16), humidity (16), and airflow (20) sensors are used for accurate and continuous sensing of heating and drying rate parameters.

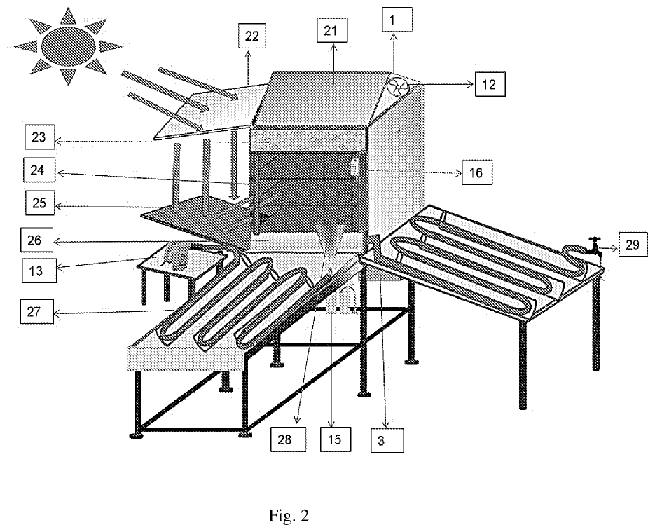

FIG. 2 represents the system diagram of the solar-based multipurpose utility system where in the system consists of different parts, like Fresnel lens with cover (21), Fresnel lens (22), ice pot (23), water pipe (24), reflector (25), water storage tank (26), phase change material (PCM) filled in evacuated tube arrangement (27), hot air sprayer (28), water tap (29), solar panel (1), battery and electronic components (3), exhaust fan (12), blower (13), water filter (15), and temperature/humidity sensor (16). The Fresnel lens with cover (21), Fresnel lens (22) and a reflector (25) are arranged in such a way that it can handle the varying heat energy requirements for cooking and ice melting by tilting the lens to align it with sun light direction as per the need. For food drying, room heating and water heating, an evacuated tube-based heating arrangement (27) is used. The evacuated tube arrangement (27) uses the thermal storage technique to let the air and water be heated for longer hours so that they can also be utilized in the absence of sunlight. The food dryer uses a blower (13) for pumping the air suction from the environment into the evacuated tube arrangement (27) for the purpose of food drying as well as room heating. The blower (13) also draws air through the air heater as well as the tubes embedded in the PCM of the energy storage in case of power cut. The blower (13) supplies the hot air to the drying chamber assisted with a hot air sprayer (28). For both ice melting and cooking, direct sunlight for top Fresnel lens (21) and reflected sunlight for lens-reflector arrangement is utilized for melting the ice kept in an ice-storage unit (23). The water obtained by the ice melting is transported to a water storage tank (26) through a water pipe (24) where it is passed either through a water filter (15) for direct use for drinking and cooking purposes through a water tap (29) or through a set of evacuated tube heating arrangement (27) for water heating purposes as per the user requirement. The solar panel (1) is used to capture solar energy and store it into battery (3) through an electronic circuit. The stored energy is used for operating exhaust fan (12), temperature and humidity sensor (16), blower (13), water filter (15) etc. in the absence of electricity or whenever it is required.

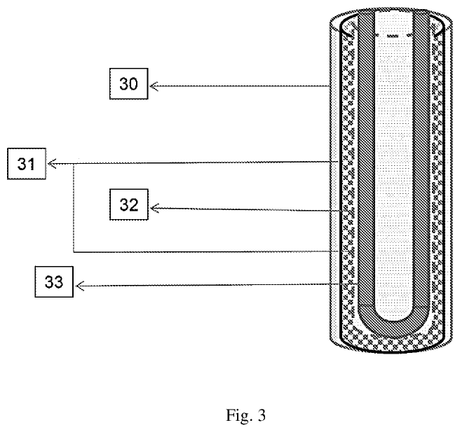

FIG. 3 represents the structural design of the evacuated tube heating arrangement which consists of different parts, namely evacuated tube collector (30), aluminium pipe layer (31), phase change material coating (32), and copper U-tube (33). The evacuated tube collector (30) is made up of double layer borosilicate glass. The heating arrangement consists of a series of evacuated tubes under which an aluminium pipe (31) is inserted and phase change material (32) is sandwiched between the two aluminium layers. Afterward, a U-shaped copper tube (33) is placed into the aluminium layered tube in such a way that it allows continuous flow of air and water through it for the heating purposes by utilizing paraffin wax and stearic acid as PCM material. This evacuated tube-based heating arrangement is used for food drying, room heating, and water heating. The evacuated tube arrangement uses the thermal storage technique to let the air and water be heated for longer hours so that they can also be utilized in the absence of sunlight.

### DETAILED DESCRIPTION

Presently, energy consumption for cooking, ice melting, room heating, water heating, food drying, water distillation is considered to be major component of total energy consumption in various households and commercial sectors. Demands and prices of fuels are increasing day by day. As an alternative fuel solar energy is a good option to utilize for various heating and cooling applications. A solar-based multipurpose utility system has been designed and fabricated especially for domestic use or for remote areas.

The solar-based multipurpose utility system consists of different sub-units, like a cooking and an ice melting unit based on a lens-reflector arrangement consisting of Fresnel lens and mirror; a room heating, water heating, and food drying units based on phase change material thermal storage technique and PCM filled evacuated tubes; a wireless remote-control unit and multiple IoT-enabled sensors for system monitoring and controlling. There is a lens-reflector arrangement fixed in a frame that is designed in such a way that it facilitates the variation of solar light reflection and refraction intensities. The Fresnel lens converge concentrate the sun's rays at a point, which get reflected through the mirror kept below; at an angle such that it could heat the dish from the bottom surface for cooking purposes. The mirror helps to reflect the heat energy obtained through the lens in a confined area and protects the food from getting easily burnt due to direct exposure of focal point of the lens into the cooking pot. The Fresnel lens and the reflector are arranged in such a way that they can handle the varying heat energy requirements for cooking and ice melting by tilting the lens to align it with sun as per the requirement. Power supply from solar panel is provided to the microcontroller, wireless module as well as other sensors and devices. The microcontroller communicates with a wireless module to initiate and transmit data to the server. Arduino microcontroller is used for reading the sensor values and monitoring data which are uploaded to the cloud through a Wi-Fi-enabled module. This IoT-based system can be accessed and remotely controlled from anywhere using the Internet. For food drying, room heating and water heating, an evacuated tube-based heating arrangement is used. The heating arrangement consists of a series of evacuated tubes, made up of borosilicate glass, under which an aluminium pipe is inserted and PCM is sandwiched between them. Afterward, a U-shaped copper tube is placed into the aluminium layered tube in such a way that it allows continuous flow of air and water through it for the heating purposes by utilizing paraffin wax and stearic acid as PCM material. The evacuated tube arrangement uses the thermal storage technique to let the air and water be heated for longer duration so that they can also be utilized in the absence of sunlight. The food dryer uses a blower for pumping the air suction from the environment into the evacuated tube arrangement for the purpose of food drying as well as room heating. Blower supplies the hot air into the drying chamber. The water obtained by the ice melting is transported to a water storage tank through a water pipe, where it is passed either through a water filter for direct use for drinking and cooking purposes or through a set of evacuated tube heating arrangement for water heating purposes as per the user requirement. The system consists of multiple IoT-based sensors that collect various data continuously and sent to the web server through wireless modules. The end-user can control the drying rate, temperature and humidity level in the dryer chamber by varying the hot air flow rate into it. These data are received by a significantly designed application interface running on mobile or a personal computer which is connected through a Wi-Fi module. All the three sensors, namely temperature, humidity, and airflow sensors are used for accurate and continuous sensing of heating and drying rate parameters. One more sensor, pyranometer is provided for measuring the solar irradiance on the planar surface of the system. The values obtained from these sensors are processed by the micro-controller. The readings can also be displayed on an OLED display connected to the apparatus in real-time. The circuit takes power from the battery being charged up through the solar panel. However, the system is designed in such a way that it can also be operated on the AC mains and it is also capable of running the household appliances with the stored solar energy.

Accordingly, the present invention provides a solar based multipurpose utility system for performing multiple tasks such as cooking, ice melting, room heating, food drying and water heating in combination of lens-reflector arrangement consisting of Fresnel lens, mirror reflector, evacuated tubes, temperature/humidity sensor, air flow sensor, wireless system for sending data on cloud server, and other analog circuits.

In an embodiment, the present invention provides a solar-based multipurpose system for cooking, drying, water/room heating, and ice melting designed for smooth power flow wherein the system comprises solar panel (1), charge controller (2), battery (3), inverter (4), supply for external sources (5), change-over circuit (6), AC-DC converter (7), mains AC supply (8), external AC supply source (9), DC-DC converter (10), voltage regulator (11), exhaust fan (12), blower (13), positive temperature coefficient (PTC) air heater (14), water filter (15), temperature and humidity sensor (16), microcontroller (17), wireless module (18), OLED display (19), and air flow meter (20); wherein different sub-units perform various functions; the solar panel (1) absorbs rays of sunlight and converts it into electricity; the 24 V solar panel (1) is connected to the solar charge controller (2) and then a 24 V battery (3) is connected to the charge controller (2); an inverter (4) is connected to the battery (3); the output of the inverter (4) is then connected to the supply for external sources (5); an external AC supply (9) is connected to AC mains supply (8) which provides input to the rectifier circuit (7); the changeover circuit (6) takes input from both battery (3) and rectifier (7); a buck boost DC-DC converter (10) provides 12 V DC supply to blower (13), PTC air heater (14), water filter (15) and exhaust fan (12); a 5 V regulated output is provided to the microcontroller (17) from a voltage regulator (11) connected to buck boost DC-DC converter (10) which processes the values obtained from different sensors namely temperature, humidity (16) and air flow sensors (20); the said microcontroller (17) output is also connected to Wi-Fi module (18) and OLED display (19); the final readings are displayed on an OLED display (19); the said microcontroller (17) communicates with a wireless module (18) to initiate and transmit data to the cloud server; the system consists of multiple IoT-based sensors that collects various data continuously and transmits to the web server through wireless modules (18); and power supply from solar panel (1) is provided to the microcontroller (17), wireless module (18) and other sensors (16 and 20).

In another embodiment, the present invention provides a solar based multipurpose utility system for operation in remote locations and the system installation arrangement consists of Fresnel lens with cover (21), Fresnel lens (22), ice pot (23), water pipe (24), reflector (25), water storage tank (26), phase change material (PCM) filled in evacuated tube arrangement (27), hot air sprayer (28), water tap (29), solar panel (1), battery and electronic components (3), exhaust fan (12), blower (13), water filter (15), and temperature/humidity sensor (16); wherein the Fresnel lens with cover (21), Fresnel lens (22) and a reflector (25) are arranged in such a way that it can handle the varying heat energy requirements for cooking and ice melting by tilting the lens to align it with sun light direction as per the need; for food drying, room heating and water heating, an evacuated tube-based heating arrangement (27) is used; the said evacuated tube arrangement (27) uses the thermal storage technique to let the air and water be heated for longer hours so that they can also be utilized in the absence of sunlight; the food dryer uses a blower (13) for pumping the air suction from the environment into the evacuated tube arrangement (27) for the purpose of food drying as well as room heating; the blower (13) also draws air through the air heater as well as the tubes embedded in the PCM of the energy storage in case of power cut; the said blower (13) supplies the hot air to the drying chamber assisted with a hot air sprayer (28); for both ice melting and cooking, direct sunlight for top Fresnel lens (21) and reflected sunlight for lens-reflector arrangement is utilized for melting the ice kept in an ice-storage unit (23); the water obtained by the ice melting is transported to a water storage tank (26) through a water pipe (24) where it is passed either through a water filter (15) for direct use for drinking and cooking purposes through a water tap (29) or through a set of evacuated tube heating arrangement (27) for water heating purposes as per the user requirement; the solar panel (1) is used to capture's solar energy and store it into battery (3) through an electronic circuit; and the stored energy is used for operating exhaust fan (12), temperature and humidity sensor (16), blower (13), water filter (15) etc. in the absence of electricity or whenever it is required.

In still another embodiment of the present invention, the evacuated tube heating arrangement is designed which consists of different parts, namely evacuated tube collector (30), aluminium pipe layer (31), phase change material coating (32), and copper U-tube (33); wherein the evacuated tube collector (30) is made up of double layer borosilicate glass, and the heating arrangement consists of a series of evacuated tubes under which an aluminium pipe (31) is inserted; phase change material (32) is sandwiched between the two aluminium layers; a U-shaped copper tube (33) is placed into the aluminium layered tube in such a way that it allows continuous flow of air and water through it for the heating purposes by utilizing paraffin wax and stearic acid as PCM material; and the evacuated tube-based heating arrangement is used for food drying, room heating, and water heating.

In yet another embodiment of the present invention, rotating screw jack and hinge-based mechanism is provided for variation of temperature by adjusting inclination or height of lens and reflector arrangement to fulfil the requirement of variable heat intensity for cooking and ice melting purpose.

In still another embodiment of the present invention, a wireless control to the system is provided through IoT-based sensors and devices powered by solar panel which allows the end-user to turn on/off the system for controlling drying rate by varying rate of moisture, hot air flow rate and temperature.

In a further embodiment of the present invention, a system incorporated with solar-based water heating, food drying and room heating facilities is provided using the phase change materials for solar thermal storage along with the positive temperature coefficient (PTC) air heater with forced convection to continue drying application in case of cloudy/foggy weather.

In still further embodiment of the present invention, a system is developed which uses solar energy as the main source of power supply in energy deficit areas as well as AC mains supply as an auxiliary source for continuous operation of the system in the absence of sunlight.

In yet another embodiment of the present invention, a solar based multipurpose system is provided which comprises of a lens-reflector arrangement for cooking and ice melting, a thermal storage arrangement using phase change material and evacuated tubes for food drying and room/water heating, a wireless-remote control unit along with sensor for temperature monitoring and controlling soil nutrient analyser and a display unit to view the readings of different system parameters in real-time. The whole system consists of different sub-parts (1 to 33). There is a lens-reflector arrangement fixed in a frame that is designed in such a way that it facilitates the variation of solar light reflection and refraction intensities. The Fresnel lens (22) converge and concentrate the sun's rays at a point, which gets reflected through the mirror (25) kept below it at an angle such that it could heat the dish from the bottom surface for cooking purposes. The mirror (25) helps to reflect the heat energy obtained through lens in a confined area and protects the food from getting easily burnt due to direct exposure of focal point of the lens into the cooking pot. The Fresnel lens (22) and a reflector (25) are arranged in such a way that they can handle the varying heat energy requirements for cooking and ice melting by tilting the lens to align it with sun as per the need. Power supply from solar panel (1) is provided to the microcontroller (17), wireless module (18) as well as other sensors and devices. The microcontroller (17) communicates with a wireless module (18) to initiate and transmit data to the server. Arduino microcontroller (17) is used for reading the sensor values and monitoring data which are uploaded to the cloud through a Wi-Fi-enabled module (18). This IoT-based system can be accessed and remotely controlled from anywhere using the Internet. Therefore, this said integrated system would help in multiple domestic applications for remote areas which will allow farmers to be self-reliant and save their expense on electricity.

In physical embodiment of the multipurpose solar utility system of the present invention, the specification of different units of the system are given below; however, equivalent components can also be used wherever required. The specifications for components contributing to cooking, drying, water/room heating, and ice melting are given below.
A solar panel: 330 W

### Arduino Mega Microcontroller Board:

(i) Based on 8-bit ATmega2560 microcontroller having operating voltage of 5 V
(ii) Frequency (clock speed) is 16 MHz
(iii) Flash Memory: 256 KB of which 8 KB used by boot-loader
(iv) 54 digital input/output pins
(v) 16 analog input pins, a USB connection, a power barrel jack

### Wireless Module:

(i) Power input: 4.5 V to 9 V (10VMAX), USB-powered
(ii) Transfer rate: 110-460800 bps, Flash size: 4 Mbyte
(iii) Support UART/GPIO data communication interface and smart link networking
(iv) Working temperature: −40° C. to +125° C.
(v) Drive type: Dual high-power H-bridge

### OLED (Organic Light-Emitting Diode) Display:

(i) 128×64 resolution and 1.3-inch size
(ii) Interface type: IIC, Light colour: White
(iii) Controlling chip: SSH1106
(iv) Low power consumption: 0.04 W during normal operation
(v) Support wide voltage: 3.3-5 V DC
(vi) Operating temperature: −40° C. to +70° C.

### Sensors:

(i) Temperature and humidity sensor: DHT22 type sensor, power supply range is 3.3-6 V DC, operating range for humidity is 0-100% RH and temperature is −40° C. to 80° C.; accuracy for humidity is <±2% RH and temperature <±0.5° C.
(ii) Hot airflow sensor: 3 VDC to 10 VDC supply voltage, −20° C. to 70° C. operating temperature range
(iii) Level sensor: ultrasonic type
(iv) Pyranometer: solar irradiance sensor

### Focusing System (Lens-Reflector Arrangement):

1. Fresnel lens: Focal length: 2000 mm
2. Mirror as a reflector: plane mirror

### Solar-Based Cooking and Ice Melting:

1. Activated carbon filter
2. Ceramic fibre blanket: 1260° C. maximum temperature, 3-4.5 μm average fiber diameter, 5.075 psi average tensile strength

### Solar-Based Water Heating, Food Drying, and Room Heating System Using Phase Change Material:

1. Phase change material: (10 litre) paraffin wax and stearic acid in the ratio 4:1
2. Storage tank: 10 litre capacity
3. Pump: 12 VDC power, 700 l/h capacity, ½ inch in/out
4. Blower: 7.0-13.8 VDC operating voltage, 12 VDC rated voltage, 0.8 A current, 3500 RPM speed, 3.46 m³/min, 12*12*2.5 (cm) dimension, 49.0 dB noise level
5. Solar collector: Borosilicate double layers evacuated tube collectors, selective Coating of Aluminium Nitride & Aluminium (Al—N/Al), 47 mm outer diameter of tube, 34 mm inner diameter of tube
6. Positive Temperature Coefficient (PTC) air heater: 35 mm external width, 60 W power rating, 30 V supply voltage, 8.3 mm depth
7. Exhaust fan: 12 VDC supply, 5 W power, 0.25 A current, 2400 RPM speed, 2.4 m³/minute air volume, 12×12×2.5 cm dimension, 35 dB noise level
8. Thermal insulator: Polyurethane foam (PUF) insulation
9. Solar charge controller: 12/24 VDC controller voltage, 20 A controller rating, 20 A maximum charging current, 20 A maximum load current, Maximum solar panel capacity in 12/24 V, 240/480 W, over current, over charge, and over discharge protection, reverse protection.
10. Battery: 200 Ah rating, 12/24 V rating, 11.6/5.8 h backup time.
11. Inverter: 12/24 VDC to 220 VAC supply rating, 500 VA

### Novelty

The novel features of the solar-based multipurpose utility system of the present invention have been realized by the combination of non-obvious inventive steps of integrating the solar based multiple units such as cooker, ice melter, room heater, food dryer, and water heater with continuous monitoring of system parameters through multiple IoT-based sensors connected to the microcontroller.

The novel and inventive features of the present invention with respect to the prior art are:
1. Capable of performing various functions based on solar energy covering cooking, ice melting, room heating, food drying, and water heating.
2. Capable of providing a solar-based cooking and ice melting unit using a combination of Fresnel lens for converging and concentrating sun's rays from the top and front portion of the system which allows ice storage unit and cooking pot to be heated efficiently.
3. Capable of providing rotating screw jack and hinge-based mechanism for variation of temperature by adjusting inclination or height of lens and reflector arrangement to fulfil the requirement of variable heat intensity for cooking and ice melting purpose.
4. Capable of efficiently providing a wireless control to the system through IoT-based sensors and devices powered by solar panel which allows the end-user to turn on/off the system for controlling drying rate by varying rate of moisture, hot air flow rate and temperature.
5. Capable of providing solar-based water heating, food drying and room heating facilities using the phase change materials for solar thermal storage along with the positive temperature coefficient (PTC) air heater with forced convection to continue drying application in case of cloudy/foggy weather.
6. Capable of providing solar energy as the main source of power supply in energy deficit areas as well as AC mains supply as an auxiliary source for continuous operation of the system in the absence of sunlight.

Use of the solar-based multipurpose utility system of the present invention should be done as follows:

The developed system is especially designed for providing number of solar based units such as cooking, ice melting, room heating, food drying, and water heating, wherein the system provides a solar-based cooking and ice melting facilities using a combination of Fresnel lens for converging and concentrating sun's rays from the top and front portion of the system which allows ice storage unit and cooking pot to be heated efficiently. The system provides rotating screw jack and hinge-based mechanism for variation of temperature by adjusting inclination or height of lens and reflector arrangement to fulfil the requirement of variable heat intensity for cooking and ice melting purpose. Wireless control to the system allows the end-user to turn on/off the system for controlling drying rate by varying rate of moisture, hot air flow rate and temperature via IoT-based sensors and devices powered by solar panel. This system efficiently provides solar-based water heating, food drying, and room heating facilities using the phase change materials for solar thermal storage along with the positive temperature coefficient (PTC) air heater with forced convection to continue drying application in case of cloudy/foggy weather. For energy deficit areas, the main source of power supply is solar energy. For continuous operation of the system even in the absence of sunlight, AC mains supply acts as an auxiliary source.

### EXAMPLES

The following examples are given by way of illustration only and therefore should not be construed to limit the scope of the present invention in any manner.

### Example-1

The solar-based multipurpose utility system of the present invention was first experimented in the laboratory under simulated conditions. The complete installed system was placed in direct sunlight and operated for a long time. Then the lens and refractor arrangement were adjusted in the heat input mode for cooking and ice melting activities. For temperature variation, the rotating screw jack and hinge-based mechanism worked satisfactory by adjusting inclination or height of lens and reflector arrangement to fulfil the requirement of variable heat intensity for cooking and ice melting purpose. The system was also connected to photovoltaic modules to enable the operation of IoT-based sensors and devices. The solar light focused on the cooking and ice melting cabinets was converted into thermal energy and the temperature was monitored. Whenever the monitored parameter exceeded the prefixed threshold values for different cooking stages, an alert to adjust temperature was generated and sent to the user.

### Example-2

The presently invented system was operated at night. The system was operated for a long time using solar energy captured by photovoltaic cells and stored in the battery. The system was operated in water heating, and room heating mode. Room heater was one by one connected to the rooms having different dimensions and the performance of the system was observed. Similarly, the different capacities of water were fed to the water heating chamber and its performance was also observed. When the medium-sized room (4×4 m) was heated with the developed room heating system, it performed ideally. Likewise, the water heating system performed preferably better when operated with an input capacity of 15 m. Thermal energy storage materials are capable of storing the excess of the thermal energy during the sunshine hours and using it during the off-sun hours.

Few experimental Fresnel lens and reflector's spot intensity data along with their operating distance values are given in Table 1 and few experimental results of heating rate with time for evacuated tube heating arrangement are given in Table 2.

TABLE 1
Experimental data for lens-reflector arrangement

| | | | | | |
|---|---|---|---|---|---|
| | Distance | Direct | Reflected | | |
| | between | spot | spot | Ambient | |
| | lens and | temper- | temper- | temper- | |
| Observation | reflector | ature | ature | ature | Time |
| No. | (cm) | (° C.) | (° C.) | (° C.) | (Second) |

| | | |
|---|---|---|
| 120 | 36 | 11:30:25 |
| 118 | 32 | 15:20:22 |
| 145 | 37 | 15:40:20 |
| 220 | 39 | 11:20:30 |

TABLE 2
Experimental data for the evacuated tube heating arrangement tube

| | | Evacuated | Ambient |
|---|---|---|---|
| Observation | Time | tube inside | temperature |
| No. | (hh:mm:ss) | temperature (° C.) | (° C.) |
| 1 | 10:18:29 | 31 | 30 |
| 2 | 10:18:53 | 34 | 31 |
| 3 | 10:19:23 | 38 | 33 |
| 4 | 10:19:53 | 42 | 34 |
| 5 | 10:20:23 | 46 | 34 |
| 6 | 10:20:53 | 47 | 34 |
| 7 | 10:21:23 | 47 | 33 |
| 8 | 10:21:53 | 48 | 34 |
| 9 | 10:22:23 | 58 | 31 |
| 10 | 10:22:53 | 66 | 34 |
| 11 | 10:23:23 | 70 | 34 |
| 12 | 10:23:53 | 73 | 34 |
| 13 | 10:24:23 | 75 | 34 |
| 14 | 10:24:53 | 76 | 35 |
| 15 | 10:25:23 | 77 | 34 |
| 16 | 10:25:53 | 77 | 34 |
| 17 | 10:26:23 | 79 | 35 |
| 18 | 10:26:53 | 81 | 36 |
| 19 | 10:27:23 | 84 | 37 |
| 20 | 10:27:53 | 86 | 35 |
| 21 | 10:28:23 | 88 | 35 |
| 22 | 10:28:53 | 91 | 37 |
| 23 | 10:29:23 | 93 | 37 |
| 24 | 10:29:53 | 96 | 37 |
| 25 | 10:30:23 | 98 | 37 |
| 26 | 10:30:53 | 101 | 37 |
| 27 | 10:31:23 | 103 | 36 |
| 28 | 10:31:53 | 105 | 37 |
| 29 | 10:32:23 | 107 | 37 |
| 30 | 10:32:53 | 109 | 37 |
| 31 | 10:33:23 | 111 | 37 |
| 32 | 10:33:53 | 113 | 38 |
| 33 | 10:34:23 | 115 | 38 |
| 34 | 10:34:53 | 116 | 38 |
| 35 | 10:35:23 | 118 | 38 |
| 36 | 10:35:53 | 120 | 38 |
| 37 | 10:36:23 | 122 | 39 |
| 38 | 10:36:53 | 123 | 39 |
| 39 | 10:37:23 | 125 | 39 |
| 40 | 10:37:53 | 127 | 39 |
| 41 | 10:38:23 | 129 | 40 |
| 42 | 10:38:53 | 130 | 39 |
| 43 | 10:39:23 | 132 | 38 |
| 44 | 10:39:53 | 133 | 39 |
| 45 | 10:40:23 | 135 | 39 |
| 46 | 10:40:53 | 136 | 39 |
| 47 | 10:41:23 | 137 | 38 |
| 48 | 10:41:53 | 137 | 38 |
| 49 | 10:42:23 | 138 | 39 |
| 50 | 10:42:53 | 139 | 38 |
| 51 | 10:43:23 | 140 | 39 |
| 52 | 10:43:53 | 142 | 40 |
| 53 | 10:44:23 | 144 | 40 |

The invented system essentially enabled to perform various functions such as cooking, ice melting, food drying, water heating, and room heating. The system also helped in providing automatic temperature control during its operation. The system performed room heating and water heating using thermal storage with phase change materials and evacuated tube collectors. The system performed cooking and ice melting at different rates using a Fresnel lens and reflector arrangements. The system has provision to store energy in battery banks from both AC power supply and solar panel, thus charging of the battery bank can be done both off-site and on-site. This system also has a provision to provide power to run domestic appliances and therefore, it proves to be very useful to be installed in power deficit areas.

Therefore, it is conclusively shown that the novel features enabled by the inventive steps of the solar-based multipurpose utility system of the present invention essentially proved to be useful for inhabitants to relieve energy deficiency with an affordable and sustainable source of energy.

### Advantages of the Invention

The system efficiently performs various functions covering cooking, ice melting, room heating, food drying, and water heating.

The system accurately provides a solar-based cooking and ice melting unit using a combination of Fresnel lens for converging and concentrating sun's rays from the top and front portion of the system which allows ice storage unit and cooking pot to be heated efficiently.

The system provides rotating screw jack and hinge-based mechanism for variation of temperature by adjusting inclination or height of lens and reflector arrangement to fulfil the requirement of variable heat intensity for cooking and ice melting purpose.

The system efficiently provides a wireless control to the system through IoT-based sensors and devices powered by solar panel which allows the end-user to turn on/off the system for controlling drying rate by varying rate of moisture, hot air flow rate and temperature.

The system efficiently provides solar-based water heating, food drying and room heating facilities using the phase change materials for solar thermal storage along with the positive temperature coefficient (PTC) air heater with forced convection to continue drying application in case of cloudy/foggy weather.

The system uses solar energy as the main source of power supply in energy deficit areas as well as AC mains supply as an auxiliary source for continuous operation of the system in the absence of sunlight.

We claim:

1. A solar-based multipurpose system for cooking, drying, water/room heating, and ice melting designed for smooth power flow wherein the system comprises:
a solar panel (1), a charge controller (2), a battery (3), an inverter (4), a supply for external sources (5), a change-over circuit (6), an AC-DC converter (7), mains AC supply (8), an external AC supply source (9), a DC-DC converter (10), a voltage regulator (11), an exhaust fan (12), a blower (13), a positive temperature coefficient (PTC) air heater (14), a water filter (15), a temperature and humidity sensor (16), a microcontroller (17), a wireless module (18), an OLED display (19), and an air flow meter (20);
wherein different sub-units perform various functions:
the solar panel (1) absorbs rays of sunlight and converts it into electricity; the 24 V solar panel (1) is connected to the solar charge controller (2) and then the 24 V battery (3) is connected to the charge controller (2); the inverter (4) is connected to the battery (3); the output of the inverter (4) is then connected to the supply for external sources (5); the external AC supply (9) is connected to the AC mains supply (8) which provides input to the rectifier circuit (7); the changeover circuit (6) takes input from both the battery (3) and the rectifier (7); the buck boost DC-DC converter (10) provides 12 V DC supply to the blower (13), the PTC air heater (14), the water filter (15) and the exhaust fan (12); a 5 V regulated output is provided to the microcontroller (17) from the voltage regulator (11) connected to the buck boost DC-DC converter (10) which processes the values obtained from different sensors namely the temperature and humidity (16) and the air flow sensors (20); the said microcontroller (17) output is also connected to the Wi-Fi module (18) and the OLED display (19); the final readings are displayed on the OLED display (19); the said microcontroller (17) communicates with the wireless module (18) to initiate and transmit data to a cloud server; the system consists of multiple IoT-based sensors that collects various data continuously and transmits to the web server through the wireless modules (18); and power supply from the solar panel (1) is provided to the microcontroller (17), the wireless module (18) and the other sensors (16 and 20).

2. The solar-based multipurpose utility system as claimed in claim 1, wherein the device includes a solar-based cooking and ice melting unit using a combination of Fresnel lens (22) for converging and concentrating sun's rays from the top and front portion of the system which allows an ice storage unit and cooking pot to be heated efficiently.

3. The solar-based multipurpose utility system as claimed in claim 1, wherein the system provides a rotating screw jack and a hinge-based mechanism for variation of temperature levels by adjusting inclination or height of the lens (22) and a reflector (25) arrangement in order to fulfil the requirement of variable heat intensity for cooking and ice melting purposes.

4. The solar-based multipurpose utility system as claimed in claim 1, wherein the system is capable of providing a wireless control to the system through IoT-based sensors and devices powered by the solar panel (1) which allows the end-user to turn on/off the system for controlling drying rate by varying the value of the system parameters such as a moisture, a hot air flow rate, and a temperature.

5. The solar-based multipurpose utility system as claimed in claim 1, wherein the system efficiently provides solar-based water heating, food drying, and room heating facilities using the phase change materials for solar thermal storage along with the positive temperature coefficient (PTC) air heater with forced convection to continue drying application in case of cloudy/foggy weather.

6. The solar-based multipurpose utility system as claimed in claim 1, wherein the system uses solar energy as the main source of power supply in energy deficit areas as well as the AC mains supply as an auxiliary source for continuous operation of the system in the absence of sunlight.

7. The solar-based multipurpose utility system as claimed in claim 1, wherein the solar panel (1) is of 330 W comprising an Arduino mega microcontroller board based on 8-bit ATmega2560 microcontroller having an operating voltage of 5 V, a frequency (clock speed)—16 MHz, a flash memory—256 KB of which 8 KB used by a boot-loader, a 54 digital input/output pins, a 16 analog input pins, a USB connection and a power barrel jack.

8. The solar-based multipurpose utility system as claimed in claim 1, wherein the wireless module (18) comprises a power input of 4.5 V to 9 V (10VMAX) which is a USB-powered, transfer rate of 110-460800 bps, flash size of 4 Mbyte, support UART/GPIO data communication interface and smart link networking, working temperature in the range of minus 40° C. to plus 125° C., drive type-dual high-power H-bridge.

9. The solar-based multipurpose utility system as claimed in claim 1, wherein the OLED (Organic Light-Emitting Diode) display (19) has a 128×64 resolution and a 1.3-inch size, an interface type—IIC, a light colour—white, a controlling chip—SSH1106, has a low power consumption of 0.04 W during normal operation, supports wide voltage in the range of 3.3-5 V DC and an operating temperature in the range of minus 40° C. to plus 70° C.

10. The solar-based multipurpose utility system as claimed in claim 1, wherein the temperature and humidity sensor (16) is a DHT22 type sensor with a power supply in the range of 3.3-6 V DC, an operating range for humidity 0-100% RH and a temperature is minus 40° C. to plus 80° C.; wherein the accuracy for humidity is <±2% RH and temperature <±0.5° C.

11. The solar-based multipurpose utility system as claimed in claim 1, wherein the hot airflow sensor has a 3 VDC to 10 VDC supply voltage and an operating temperature in the range of minus 20° C. to plus 70° C.

12. The solar-based multipurpose utility system as claimed in claim 1, wherein a level sensor is an ultrasonic type and a pyranometer is based on a solar irradiance sensor.

13. The solar-based multipurpose utility system as claimed in claim 1, wherein a focusing system comprises the Fresnel lens (22) of focal length—2000 mm and a plane mirror as the reflector (25).

14. The solar-based multipurpose utility system as claimed in claim 1, wherein the cooking and ice melting unit comprises an activated carbon filter, a ceramic fibre blanket with 1260° C. maximum temperature, 3-4.5 μm average fibre diameter, 5.075 psi average tensile strength.

15. The solar-based multipurpose utility system as claimed in claim 1, wherein the phase change material comprises a paraffin wax and a stearic acid in the ratio 4:1.

16. The solar-based multipurpose utility system as claimed in claim 1, wherein a storage tank is of 10 litre capacity; pump with a 12 VDC power, 700 l/h capacity, ½ inch in/out; a blower with 7.0-13.8 VDC operating voltage, 12 VDC rated voltage, 0.8 A current, 3500 RPM speed, 3.46 m³/min, 12*12*2.5 (cm) dimension, 49.0 dB noise level; a solar collector is of a borosilicate double layers evacuated tube collectors with selective coating of an Aluminium Nitride & Aluminium (Al—N/Al), 47 mm outer diameter of tube, 34 mm inner diameter of tube; the positive Temperature Coefficient (PTC) air heater has 35 mm external width, 60 W power rating, 30 V supply voltage, 8.3 mm depth; the exhaust fan is of 12 VDC supply, 5 W power, 0.25 A current, 2400 RPM speed, 2.4 m³/minute air volume, 12×12×2.5 cm dimension, 35 dB noise level; a thermal insulator is of Polyurethane foam (PUF) insulation; the solar charge controller (2) with 12/24 VDC controller voltage, 20 A controller rating, 20 A maximum charging current, 20 A maximum load current, maximum solar panel capacity in 12/24 V, 240/480 W, over current, and over discharge protection, reverse protection; battery of 200 Ah rating, 12/24 V rating, 11.6/5.8 h backup time; and inverter of 12/24 VDC to 220 VAC supply rating, 500 VA.
